(19) United States
(12) Patent Application Publication
(10) Pub. No.: US 2020/0234187 A1
(43) Pub. Date: Jul. 23, 2020

(54) INFORMATION PROCESSING APPARATUS, INFORMATION PROCESSING METHOD, AND PROGRAM

(71) Applicant: SONY CORPORATION, TOKYO (JP)

(72) Inventors: KUNIAKI TORII, KANAGAWA (JP); NORIFUMI KIKKAWA, TOKYO (JP); NAOYUKI SATO, TOKYO (JP)

(21) Appl. No.: 16/650,430

(22) PCT Filed: Aug. 2, 2018
(86) PCT No.: PCT/JP2018/028959

§ 371 Date: Mar. 25, 2020

(30) Foreign Application Priority Data
Oct. 11, 2017 (JP) 2017-197576

(51) Int. Cl. G06N 20/00; G10L 15/06

(52) U.S. Cl. CPC G06N 20/00; G10L 15/06

(57) ABSTRACT

To cause a user to more naturally and intuitively perceive learning progress regarding information presentation. Provided is an information processing apparatus including an output control unit configured to control an output of response information to a user, in which the output control unit controls output expression of the response information on the basis of learning progress of learning regarding generation of the response information. Furthermore, provided is an information processing method including, by a processor, controlling an output of response information to a user, the controlling further including controlling output expression of the response information on the basis of learning progress of learning regarding generation of the response information.

### TECHNICAL FIELD

The present disclosure relates to an information processing apparatus, an information processing method, and a program.

### BACKGROUND ART

In recent years, various apparatuses for presenting information to a user using voice or visual information have become widespread. Furthermore, many technologies for improving user convenience regarding information presentation as described above have been developed. For example, Patent Document 1 discloses a technology for defining the quality of information presentation on the basis of an information search level and performing output control according to the information search level.

### CITATION LIST

### Patent Document

Patent Document 1: Japanese Patent Application Laid-Open No. 2016-136355

### SUMMARY OF THE INVENTION

### Problems to be Solved by the Invention

By the way, the quality of the information output by the apparatus as described above has a close correlation with learning progress regarding information presentation. However, it is difficult for the user to grasp the learning progress of the apparatus by the technology described in Patent Document 1.

In view of the foregoing, the present disclosure proposes new and improved information processing apparatus, information processing method, and program capable of causing a user to more naturally and intuitively perceive learning progress regarding information presentation.

### Solutions to Problems

According to the present disclosure, provided is an information processing apparatus including an output control unit configured to control an output of response information to a user, in which the output control unit controls output expression of the response information on the basis of learning progress of learning regarding generation of the response information.

Furthermore, according to the present disclosure, provided is an information processing method including, by a processor, controlling an output of response information to a user, the controlling further including controlling output expression of the response information on the basis of learning progress of learning regarding generation of the response information.

Furthermore, according to the present disclosure, provided is a program for causing a computer to function as an information processing apparatus including an output control unit configured to control an output of response information to a user, in which the output control unit controls output expression of the response information on the basis of learning progress of learning regarding generation of the response information.

### Effects of the Invention

As described above, according to the present disclosure, the user can more naturally and intuitively perceive learning progress regarding information presentation.

Note that the above-described effect is not necessarily limited, and any of effects described in the present specification or another effect that can be grasped from the present specification may be exerted in addition to or in place of the above-described effect.

### BRIEF DESCRIPTION OF THE DRAWINGS

FIG. 1 is a diagram for describing an overview of output control according to an embodiment of the present disclosure.

FIG. 2 is a block diagram illustrating a configuration example of an information processing system according to the embodiment.

FIG. 3 is a block diagram illustrating a functional configuration example of an information processing terminal according to the embodiment.

FIG. 4 is a block diagram illustrating a functional configuration example of an information processing server according to the embodiment.

FIG. 5 is a diagram for describing calculation of learning progress based on a feedback according to the embodiment.

FIG. 6 is a diagram for describing output control of additional information regarding a feedback request according to the embodiment.

FIG. 7 is a flowchart illustrating a flow of control of output expression based on learning progress by the information processing server according to the embodiment.

FIG. 8 is a flowchart illustrating a flow of output control of additional information regarding a feedback request by the information processing server according to the embodiment.

FIG. 9 is a flowchart illustrating a flow of update of a learning function based on a feedback by the information processing server according to the embodiment.

FIG. 10 is a diagram illustrating a hardware configuration example of the information processing server according to the embodiment of the present disclosure.

### MODE FOR CARRYING OUT THE INVENTION

Favorable embodiments of the present disclosure will be described in detail below with reference to the accompanying drawings. Note that, in the present specification and the drawings, redundant description of constituent elements having substantially the same functional configurations is omitted by giving the same reference numerals.

Note that the description will be given in the following order.

1. Embodiment

1.1. Overview

1.2. System Configuration Example

1.3. Functional Configuration Example of Information Processing Terminal 10

1.4. Functional Configuration Example of Information Processing Server 20

1.5. Calculation of Learning Progress

1.6. Output Control of Additional Information Regarding Feedback Request

1.7. Flow of Control

2. Hardware Configuration Example

3. Conclusion

### 1. FIRST EMBODIMENT

<<1.1. Overview>>

In recent years, various apparatuses for presenting information to a user using a technique of machine learning or the like have become widespread. Examples of such apparatuses include an agent device that presents information to the user using voice utterances or visual information. The agent device can respond with response information and the like to a user's inquiry, for example, by outputting a voice utterance, displaying visual information, or the like.

At this time, the quality of the response information output by the agent device has a close correlation with learning progress regarding generation of the response information. For this reason, in order for the agent device to output more useful response information, a mechanism for collecting a feedback to the response information by the user and reflecting the feedback on the learning is important.

As a means for collecting a feedback as described above, there is a technique of collecting evaluations for output response information by pressing a button or filling in a questionnaire, for example. In many cases, however, evaluation items and evaluation timing are statically determined regardless of learning progress.

For this reason, even in situations where the feedback is more important, such as early stages of using the agent device or when facing a use case with a low frequency of occurrence, the user cannot grasp the situation, and it has been difficult to realize efficient learning.

Furthermore, continuously requesting the user to provide a detailed feedback on a constant basis regardless of the learning progress is assumed, but in this case, an input burden on the user increases. Moreover, a situation is assumed in which the user becomes fed up with repeated requests of redundant content, and the feedback itself cannot be collected.

The information processing apparatus, the information processing method, and the program according to the embodiment of the present disclosure have been conceived focusing on the above points, and cause the user to more naturally perceive the learning progress regarding information presentation, thereby realizing more efficient feedback collection. For this purpose, one of characteristics of the information processing apparatus for realizing the information processing method according to the present embodiment is to control output expression of response information on the basis of learning progress regarding generation of the response information.

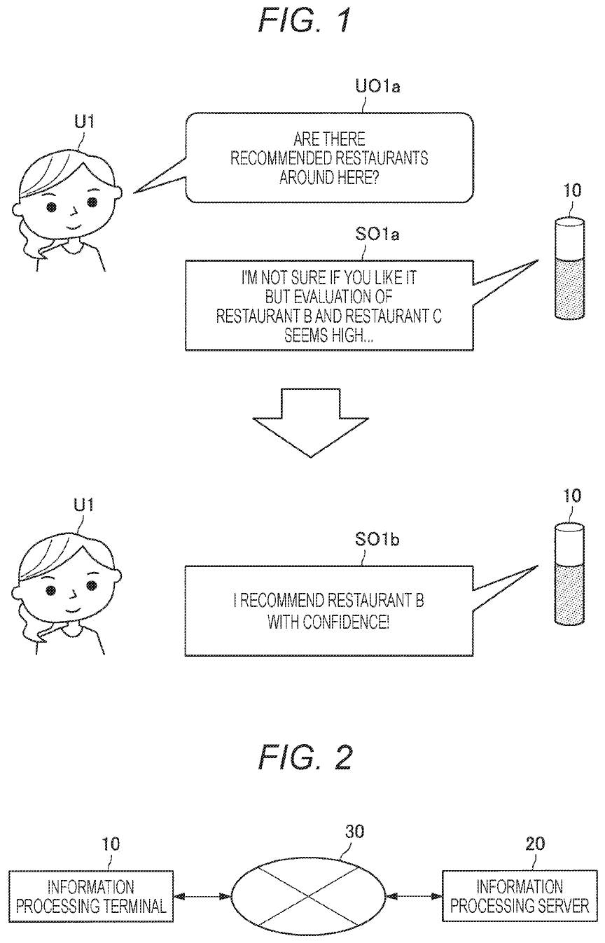

FIG. 1 is a diagram for describing an overview of an embodiment of the present disclosure. The upper part in FIG. 1 illustrates a user U1 who makes a user utterance UO1a regarding a restaurant inquiry, and an information processing terminal 10 that outputs response information to the user utterance UO1a by a voice utterance SO1a.

Note that the upper part in FIG. 1 illustrates an example of a case in which the learning progress regarding restaurant recommendation is relatively low. That is, the example in the upper part in FIG. 1 illustrates a situation in which there is a possibility that usefulness of response information regarding the restaurant recommended by the system is not high for the user U1 due to factors such as a small number of learnings regarding a liking of the user U1.

At this time, an information processing server 20 according to the present embodiment determines output expression suggesting the above situation on the basis of the fact that the learning progress regarding restaurant recommendation is relatively low, and can cause the information processing terminal 10 to output response information synthesized with the output expression.

For example, the information processing server 20 according to the present embodiment may synthesize output expression indicating that there is no confidence in the usefulness of the response information with the response information. Specifically, in the present example, the information processing server 20 inserts a sentence “I'm not sure if you like it” into the beginning of a sentence, and synthesizes relatively low reliable expression “evaluation seems high” with the response information.

Furthermore, the information processing server 20 may synthesize output expression with suppressed volume and inflection regarding the voice utterance SO1a with the response information. Note that, in the drawings used in the present disclosure, font size and text decoration of the sentence corresponding to the voice utterance respectively correspond to the volume and the inflection of the voice utterance.

As described above, according to the information processing server 20 and the information processing terminal 10 of the present embodiment, controlling the output expression of the response information enables the user to naturally and intuitively perceive the low learning progress, thereby effectively promoting a positive feedback by the user.

Meanwhile, the lower part in FIG. 1 illustrates an example of a case in which the learning progress regarding restaurant recommendation is relatively high. At this time, the information processing server 20 according to the present embodiment determines output expression suggesting that the usefulness of the response information being high for the user U1 has been determined, and can cause the information processing terminal 10 to output response information synthesized with the output expression as a voice utterance SO1b.

For example, the information processing server 20 according to the present embodiment may synthesize output expression indicating that there is confidence in the usefulness of the response information with the response information. Specifically, in the case of the present example, the information processing server 20 inserts a sentence “with confidence” into the beginning of the sentence and synthesizes definitive expression with the response information.

Furthermore, the information processing server 20 may synthesize output expression with increased volume and inflection regarding the voice utterance SO1b with the response information.

According to the information processing server 20 and the information processing terminal 10 of the present embodiment, controlling the output expression of the response information enables the user to naturally and intuitively perceive the high learning progress, thereby emphasizing, to the user, that the feedback by the user is appropriately reflected in learning, or the like, for example.

<<1.2. System Configuration Example>>

Next, a configuration example of an information processing system according to the present embodiment will be described. FIG. 2 is a block diagram illustrating a configuration example of an information processing system according to the present embodiment. Referring to FIG. 2, the information processing system according to the present embodiment includes the information processing terminal 10 and the information processing server 20. Furthermore, the information processing terminal 10 and the information processing server 20 are connected so as to communicate with each other via a network 30.

(Information Processing Terminal 10)

The information processing terminal 10 according to the present embodiment is an information processing apparatus that outputs response information using voice or visual information to a user on the basis of control by the information processing server 20. One of characteristics of the information processing terminal 10 according to the present embodiment is to output response information on the basis of output expression dynamically determined by the information processing server 20 on the basis of learning progress.

The information processing terminal 10 according to the present embodiment can be realized as various devices having a function to output voice and visual information. The information processing terminal 10 according to the present embodiment may be, for example, a mobile phone, a smartphone, a tablet, a wearable device, a general-purpose computer, a stationary-type or an autonomous mobile-type dedicated device, and the like.

Furthermore, the information processing terminal 10 according to the present embodiment has a function to collect various types of information regarding the user and a surrounding environment. The information processing terminal 10 collects, for example, sound information including a user's utterance, input sentence input by the user by device operation, image information obtained by capturing the user and surroundings, and other various types of sensor information, and transmits the information to the information processing server 20.

(Information Processing Server 20)

The information processing server 20 according to the present embodiment is an information processing apparatus that controls output of response information to the user. At this time, one of characteristics of the information processing server 20 according to the present embodiment is to control output expression of response information on the basis of learning progress of learning regarding generation of the response information. Specifically, the information processing server 20 according to the present embodiment may synthesize the output expression determined on the basis of the learning progress with the response information generated on the basis of input information.

(Network 30)

The network 30 has a function to connect the information processing terminal 10 and the information processing server 20. The network 30 may include a public network such as the Internet, a telephone network, and a satellite network, various local area networks (LAN) including Ethernet (registered trademark), a wide area network (WAN), and the like. Furthermore, the network 30 may include a leased line network such as an internet protocol-virtual private network (IP-VPN). Furthermore, the network 30 may include a wireless communication network such as Wi-Fi (registered trademark) and Bluetooth (registered trademark).

A configuration example of the information processing system according to the present embodiment has been described. Note that the above-described configuration described with reference to FIG. 2 is merely an example, and the configuration of the information processing system according to the present embodiment is not limited to the example. For example, the functions of the information processing terminal 10 and the information processing server 20 according to the present embodiment may be realized by a single device. The configuration of the information processing system according to the present embodiment can be flexibly modified according to specifications and operations.

<<1.3. Functional Configuration Example of Information Processing Terminal 10>>

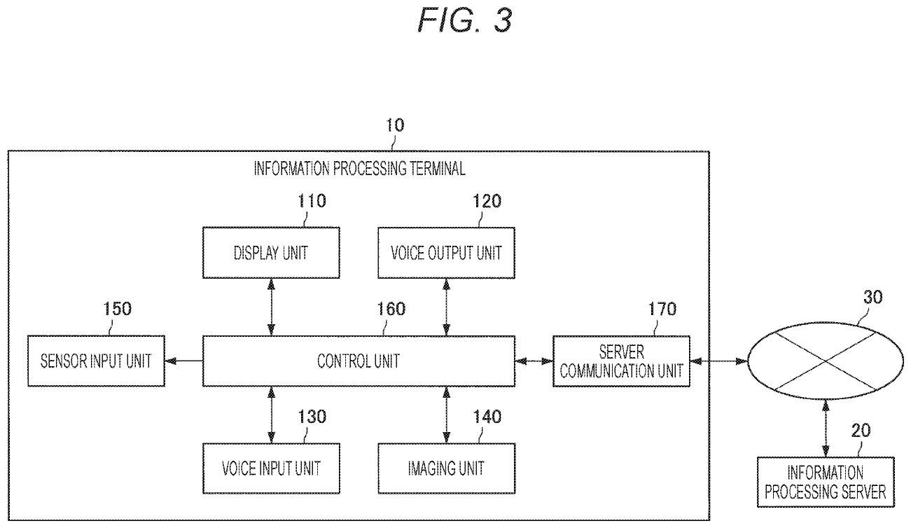

Next, a functional configuration example of the information processing terminal 10 according to the present embodiment will be described. FIG. 3 is a block diagram illustrating a functional configuration example of the information processing terminal 10 according to the present embodiment. Referring to FIG. 3, the information processing terminal 10 according to the present embodiment includes a display unit 110, a voice output unit 120, a voice input unit 130, an imaging unit 140, a sensor input unit 150, a control unit 160, and a server communication unit 170.

(Display Unit 110)

The display unit 110 according to the present embodiment has a function to output visual information such as images and texts. The display unit 110 according to the present embodiment displays texts and images corresponding to the response information on the basis of control by the information processing server 20, for example.

For this purpose, the display unit 110 according to the present embodiment includes a display device for presenting the visual information, and the like. Examples of the display device include a liquid crystal display (LCD) device, an organic light emitting diode (OLED) device, a touch panel, and the like. Furthermore, the display unit 110 according to the present embodiment may output the visual information using a projection function.

(Voice Output Unit 120)

The voice output unit 120 according to the present embodiment has a function to output various sounds including voice utterances. The voice output unit 120 according to the present embodiment outputs a voice utterance corresponding to the response information on the basis of control by the information processing server 20, for example. For this purpose, the voice output unit 120 according to the present embodiment includes a voice output device such as a speaker and an amplifier.

(Voice Input Unit 130)

The voice input unit 130 according to the present embodiment has a function to collect sound information such as utterances by the user and ambient sounds generated around the information processing terminal 10. The sound information collected by the voice input unit 130 is used for voice recognition, recognition of the surrounding environment, and the like by the information processing server 20. The voice input unit 130 according to the present embodiment includes a microphone for collecting the sound information.

(Imaging Unit 140)

The imaging unit 140 according to the present embodiment has a function to capture an image of the user and the surrounding environment. Image information captured by the imaging unit 140 is used for behavior recognition and state recognition of the user and recognition of the surrounding environment by the information processing server 20. The imaging unit 140 according to the present embodiment includes an imaging device that can capture an image. Note that the above image includes a moving image in addition to a still image.

(Sensor Input Unit 150)

The sensor input unit 150 according to the present embodiment has a function to collect various types of sensor information regarding the surrounding environment and a behavior and a state of the user. Sensor information collected by the sensor input unit 150 is used for the recognition of the surrounding environment, and the behavior recognition and state recognition of the user by the information processing server 20. The sensor input unit 150 includes, for example, an optical sensor including an infrared sensor, an acceleration sensor, a gyro sensor, a geomagnetic sensor, a thermal sensor, a vibration sensor, a global navigation satellite system (GNSS) signal receiving device, and the like.

Furthermore, the sensor input unit 150 according to the present embodiment has a function to detect an input sentence input by a user by device operation. For this purpose, the sensor input unit 150 according to the present embodiment includes, for example, a keyboard, a touch panel, a mouse, various buttons, and the like.

(Control Unit 160)

The control unit 160 according to the present embodiment has a function to control configurations included in the information processing terminal 10. The control unit 160 controls, for example, start and stop of the configurations. Furthermore, the control unit 160 inputs a control signal generated by the information processing server 20 to the display unit 110 and the voice output unit 120. Furthermore, the control unit 160 according to the present embodiment may have a function equivalent to an output control unit 270 of the information processing server 20 to be described below.

(Server Communication Unit 170)

The server communication unit 170 according to the present embodiment has a function to perform information communication with the information processing server 20 via the network 30. Specifically, the server communication unit 170 transmits the sound information collected by the voice input unit 130, the image information captured by the imaging unit 140, and the sensor information collected by the sensor input unit 150 to the information processing server 20. Furthermore, the server communication unit 170 receives a control signal regarding output of response information from the information processing server 20, and the like.

A functional configuration example of the information processing terminal 10 according to the present embodiment has been described. Note that the above-described configuration described with reference to FIG. 3 is merely an example, and the functional configuration of the information processing terminal 10 according to the present embodiment is not limited to the example. For example, the information processing terminal 10 according to the present embodiment does not necessarily have all of the configurations illustrated in FIG. 3. For example, the information processing terminal 10 can have a configuration without including the display unit 110, the sensor input unit 150, and the like. Furthermore, as described above, the control unit 160 according to the present embodiment may have a function equivalent to the output control unit 270 of the information processing server 20. The functional configuration of the information processing terminal 10 according to the present embodiment can be flexibly modified according to specifications and operations.

<<1.4. Functional Configuration Example of Information Processing Server 20>>

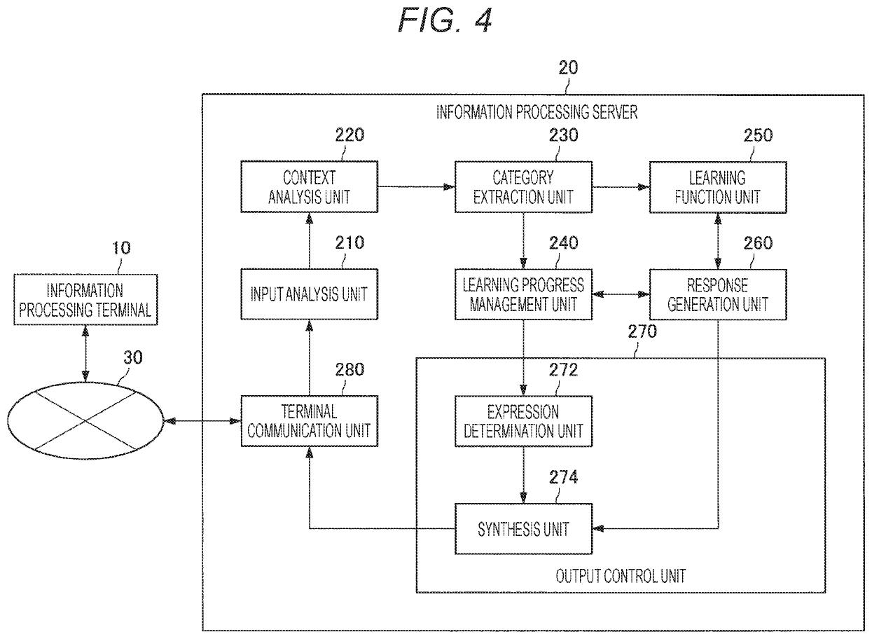

Next, a functional configuration example of the information processing server 20 according to the present embodiment will be described in detail. FIG. 4 is a block diagram illustrating a functional configuration example of the information processing server 20 according to the present embodiment. Referring to FIG. 4, the information processing server 20 according to the present embodiment includes an input analysis unit 210, a context analysis unit 220, a category extraction unit 230, a learning progress management unit 240, a learning function unit 250, a response generation unit 260, the output control unit 270, and a terminal communication unit 280. Furthermore, the output control unit 270 according to the present embodiment includes an expression determination unit 272 and a synthesis unit 274.

(Input Analysis Unit 210)

The input analysis unit 210 according to the present embodiment has a function to analyze the sound information regarding a user's utterance collected by the information processing terminal 10 and the input sentence input by device operation, and convert the information into information usable by other configuration. For example, the input analysis unit 210 according to the present embodiment may convert the sound information regarding a user's utterance into word-level text.

Furthermore, the input analysis unit 210 according to the present embodiment may perform recognition regarding the state and action of the user, and the surrounding environment. The input analysis unit 210 can recognize, for example, a user's line-of-sight, facial expression, emotion, behavior, and the like on the basis of the collected image information. Furthermore, the input analysis unit 210 can also estimate characteristics of a location where the user is located on the basis of, for example, the image information and the sensor information.

(Context Analysis Unit 220)

The context analysis unit 220 according to the present embodiment has a function to analyze context regarding a user input on the basis of the information analyzed and converted by the input analysis unit 210. Here, the above-described context may include elements such as WHERE, WHEN, WHO, WHAT, and the like regarding the input content, for example.

For example, in the case of the user utterance SO1 illustrated in FIG. 1, the context analysis unit 220 can extract WHERE=around here and WHAT=a recommended restaurant on the basis of the text converted by the input analysis unit 210. Furthermore, in this case, the context analysis unit 220 may supplement information such as WHEN=current time and WHO=user U1 to elements that are not specified and extract information.

(Category Extraction Unit 230)

The category extraction unit 230 according to the present embodiment has a function to extract a category of the learning regarding generation of the response information on the basis of the information analyzed by the input analysis unit 210 and the context extracted by the context analysis unit 220.

The category according to the present embodiment refers to a unit regarding management of the learning progress. That is, the learning progress according to the present embodiment may be calculated for each category. The category according to the present embodiment may be determined on the basis of, for example, an inquiry purpose (=WHAT) such as a travel destination or a restaurant. Furthermore, the category according to the present embodiment may be determined on the basis of a target user (=WHO) such as an individual user, a user's family, or the like.

Furthermore, the category according to the present embodiment may be determined on the basis of the nature of a learning device. The category according to the present embodiment can include, for example, image recognition, voice recognition, machine control, and the like.

(Learning Progress Management Unit 240)

The learning progress management unit 240 according to the present embodiment has a function to dynamically calculate the learning progress for each category described above. The learning progress management unit 240 according to the present embodiment can calculate the learning progress in which determination factors such as the number of learnings, a learning history, reliability, and the like, have been comprehensively considered, for the category extracted by the category extraction unit 230. Note that the function of the learning progress management unit 240 according to the present embodiment will be separately described in detail.

(Learning Function Unit 250)

The learning function unit 250 according to the present embodiment has a function to perform learning based on input information using an algorithm such as deep learning. As described above, the learning function unit 250 according to the present embodiment may perform learning regarding the image recognition, voice recognition, and machine control in addition to learning of an answer to a user's inquiry, or the like. Furthermore, the learning algorithm according to the present embodiment is not limited to the above example, and may be appropriately selected according to a characteristic of the generated response information.

(Response Generation Unit 260)

The response generation unit 260 according to the present embodiment has a function to generate the response information using knowledge learned by the learning function unit 250.

(Output Control Unit 270)

The output control unit 270 according to the present embodiment has a function to control output of the response information to the user. At this time, one of characteristics of the output control unit 270 according to the present embodiment is to control the output expression of the response information on the basis of the learning progress calculated by the learning progress management unit 240.

Furthermore, the output control unit 270 according to the present embodiment further controls output of additional information that requests the user to provide a feedback to the response information. The function of the output control unit 270 according to the present embodiment will be separately described in detail.

The output control unit 270 according to the present embodiment may include, for example, the expression determination unit 272 and the synthesis unit 274.

((Expression Determination Unit 272))

The expression determination unit 272 according to the present embodiment has a function to determine the output expression to be synthesized with the response information on the basis of the learning progress calculated by the learning progress management unit 240. At this time, the expression determination unit 272 according to the present embodiment may determine the output expression on the basis of the learning progress calculated for each category.

More specifically, the expression determination unit 272 according to the present embodiment can determine the output expression for causing the user to perceive the learning progress on the basis of the learning progress calculated by the learning progress management unit 240.

For example, the expression determination unit 272 according to the present embodiment may determine the output expression suggesting that there is a possibility that the usefulness of the response information to the user is not high in a case where the learning progress is low. The expression determination unit 272 may determine the output expression indicating that there is no confidence in the usefulness of the response information, as in the example illustrated in FIG. 1. More specifically, for example, the expression determination unit 272 may determine the output expression for reducing the volume regarding a voice utterance, vibrating the voice, outputting a sound to be hard to hear, or the like, or the output expression for reducing or thinning characters regarding the visual information, selecting a font with low visibility, or the like.

Meanwhile, in a case where the learning progress is high, the expression determination unit 272 may determine the output expression suggesting that the usefulness of the response information to the user being high has been determined. For example, the expression determination unit 272 can determine the output expression indicating that there is confidence in the usefulness of the response information, as in the example illustrated in FIG. 1. More specifically, the expression determination unit 272 may determine the output expression of increasing the volume regarding a voice utterance, clearly pronouncing words, or the like, or the output expression of increasing or darkening characters regarding the visual information, selecting a font with high visibility, or the like, for example.

To realize the output expression as described above, the expression determination unit 272 according to the present embodiment has a function to dynamically change the sentence content, the output mode, the output operation, and the like regarding the response information on the basis of the learning progress calculated for each category.

Here, the above-described output mode refers to auditory or visual expression regarding output of the response information. In a case of outputting the response information by a voice utterance, the expression determination unit 272 can control, for example, the voice quality, volume, prosody, output timing, effect, and the like, of the voice utterance. Note that the above-described prosody includes sound rhythm, strength, length, and the like.

Furthermore, in a case of causing the response information to be output as visual information, the expression determination unit 272 can control, for example, the font, size, color, character decoration, layout, animation, and the like of the response information. According to the function of the expression determination unit 272 of the present embodiment, the user can effectively perceive the learning progress by changing the auditory or visual expression regarding the response information according to the learning progress.

Furthermore, the above-described output operation refers to a physical operation of the information processing terminal 10 or an operation of a character or the like displayed as the visual information, regarding the output of the response information. For example, in a case where the information processing terminal 10 is a robot imitating a human being or an animal, the output operation may include movement of parts such as limbs, facial expressions including line-of-sight, blinking, and the like, for example. Furthermore, the output operation includes various physical operations using light and vibration, for example. According to the function of the expression determination unit 272 of the present embodiment, the information processing terminal 10 can be caused to perform a flexible output operation according to the learning progress.

((Synthesis Unit 274))

The synthesis unit 274 according to the present embodiment has a function to synthesize the output expression determined on the basis of the learning progress by the expression determination unit 272 with the response information generated by the response generation unit 260.

(Terminal Control Unit 280)

The terminal communication unit 280 according to the present embodiment has a function to perform information communication with the information processing terminal 10 via the network 30. Specifically, the terminal communication unit 280 receives the sound information, input sentence, image information, and sensor information from the information processing terminal 10. Furthermore, the terminal communication unit 280 transmits a control signal regarding the output of response information to the information processing terminal 10.

Heretofore, the functional configuration example of the information processing server 20 according to the present embodiment has been described. Note that the above-described configuration described with reference to FIG. 4 is merely an example, and the functional configuration of the information processing server 20 according to the present embodiment is not limited to the example. For example, the input analysis unit 210, the context analysis unit 220, the category extraction unit 230, the learning progress management unit 240, the learning function unit 250, the response generation unit 260, and the like can be provided in a different device from the information processing server 20.

Furthermore, as described above, the function of the output control unit 270 according to the present embodiment may be realized as the function of the control unit 160 of the information processing terminal 10. That is, the function of the output control unit 270 according to the present embodiment can be realized as a function on both the server side and the client side. For example, in a case where the function is provided as the function of the information processing server 20, the user can enjoy services on various information processing terminals 10. Meanwhile, in a case where the information processing terminal 10 has an equivalent function to the output control unit 270, the learning progress management unit 240, the learning function unit 250, the response generation unit 260, and the like, offline use and more secure storage of personal information, and the like become possible. The functional configuration of the information processing server 20 according to the present embodiment can be flexibly modified according to specifications and operations.

<<1.5. Calculation of Learning Progress>>

Next, calculation of the learning progress according to the present embodiment will be described in detail. As described above, the learning progress management unit 240 according to the present embodiment can dynamically calculate the learning progress for each category. At this time, the learning progress management unit 240 according to the present embodiment may calculate the learning progress using a factor value regarding the determination factor and a weighting factor for each determination factor.

Here, the above-described determination factor may include, for example, the number of learnings, the learning history, the reliability, and the like. Note that the number of learnings includes the number of uses, the number of feedbacks from the user, and the like. In a case where a log, the number of rule applications, the number of feedbacks, and the like are large, for example, the learning progress management unit 240 may calculate the factor value of the number of learnings to be high.

Furthermore, the learning history may include a period since the last use, the frequency and the number of most recent negative feedbacks, and the like. The learning progress management unit 240 may calculate the factor value of the learning history to be higher as the period since the last use is shorter, or may calculate the factor value to be low in a case where the frequency and the number of most recent negative feedbacks are large, for example.

Furthermore, the result of output by the learning function unit 250 may be taken into consideration for the above-described reliability. For example, in learning for general-purpose matters such as information search, the learning progress management unit 240 may calculate the factor value to be high in a case where a range of data search is wide or an error of a data search determination result is small. Furthermore, in recognition processing such as image recognition or voice recognition, the learning progress management unit 240 can also use a value of the reliability for a recognition result determined by a recognition module as the factor value.

Here, in a case where the number of learnings is f, the learning history is g, and the reliability is q, the learning progress according to the present embodiment may be calculated as, for example, the learning progress=wₐ*f+w_{b}*g+w_{c}*q. However, wₐ to w_{c} in the above expression are weighting factors for the number of learnings f, the learning history g, and the reliability q, respectively.

Furthermore, at this time, the learning progress management unit 240 according to the present embodiment may dynamically determine the weighting factors wₐ to w₀ according to a characteristic of a category of learning, for example.

For example, for learning regarding user characteristics such as user preferences, the number of learnings f and the learning history g are important determination factors. Therefore, the learning progress management unit 240 may set the weighting factors wₐ and w_{b} to be large and the weighting factor w_{c} to be small.

Furthermore, for example, for learning regarding fields where change is relatively large in a short period such as a trend of the world, the latest learning history g is important. Therefore, the learning progress management unit 240 may set the weighting factor w_{b} to be large.

Furthermore, for example, in the case of image recognition or voice recognition, the number of learnings f and the reliability q are important determination factors. Therefore, the learning progress management unit 240 may set the weighting factors wₐ and w_{c} to be large.

Furthermore, for example, in the case of general-purpose matters such as information search, the range and accuracy of the data search are dominant. Therefore, the learning progress management unit 240 may set the weighting factor w_{c} to be large. However, since the freshness of data is important in fields where the effective period of information is short, the learning progress management unit 240 places importance on a period since data was last used and may set the weighting factor w_{b} to be large.

Thus, the learning progress management unit 240 according to the present embodiment can dynamically calculate the learning progress according to various situations. Therefore, it can be said that the learning progress according to the present embodiment does not irreversibly increase but is a value that reversibly increases or decreases.

For example, in a case where data has not been used for a while in the fields where the change is large, the weighting factor w_{b} for the learning history g becomes dominant and the factor value of the learning history g becomes small, so the learning progress decreases.

Furthermore, even if the factor value of the number of learnings f is high, if the frequency and the number of most recent negative feedbacks are large, the factor value of the learning history g becomes small, so the learning progress decreases.

Furthermore, for example, in a case where the number of unlearned areas increases, for example, the number of objects to be recognized increases, the factor value of the reliability q becomes small, so the learning progress decreases.

Thus, according to the learning progress management unit 240 of the present embodiment, learning progress with high accuracy according to the situation can be dynamically and reversibly calculated.

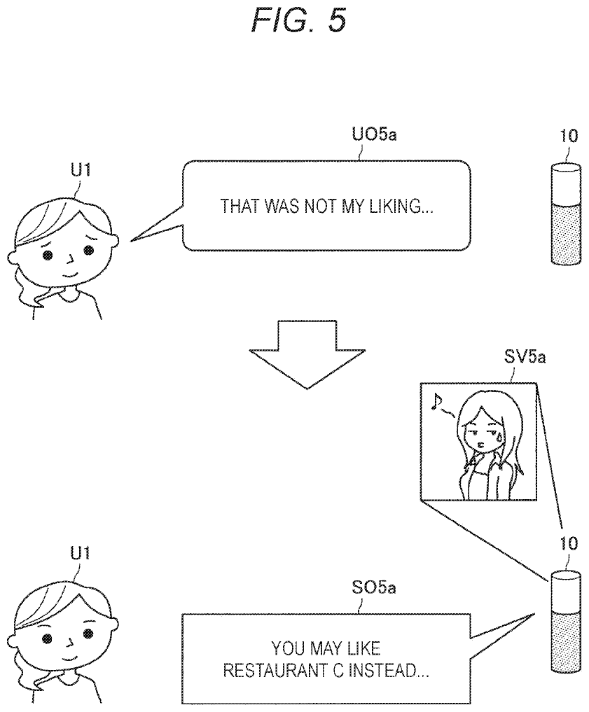

Furthermore, the learning progress management unit 240 according to the present embodiment may recalculate the learning progress at the timing of receiving a user feedback to the response information. FIG. 5 is a diagram for describing calculation of the learning progress based on a feedback according to the present embodiment.

The upper part in FIG. 5 illustrates an example of a case where the user U1 has performed a user utterance UO5a as a negative feedback to the response information output from the information processing terminal 10. Note that the user utterance UO5a illustrated in FIG. 5 may have been performed for the voice utterance SO1b illustrated in FIG. 1. In this case, although the number of learnings increases due to receiving the negative feedback, it can be said that the learning progress is not good as the accuracy of learning.

Therefore, the learning progress management unit 240 according to the present embodiment may calculate the factor value so as to make the learning history g small while making the number of learnings f high. Furthermore, the learning progress management unit 240 may adjust the weighting factors wₐ to w_{c} so that the learning history g is significantly reduced after the above processing.

Furthermore, in a case of receiving a negative feedback to the response information output in a state where the learning progress is determined to be high, the learning progress management unit 240 can calculate the influence of the learning history g to be larger than a normal case, for example. In this case, progress of erroneous learning can be prevented and a correct feedback can be sought from the user.

Furthermore, the output control unit 270 according to the present embodiment determines the output expression on the basis of the learning progress recalculated as described above, thereby causing the information processing terminal 10 to output the response information based on the learning progress with high accuracy each time. In the case of the example illustrated in FIG. 5, the output control unit 270 causes the information processing terminal 10 to output a voice utterance SO5a and visual information SV5a synthesized with the output expression suggesting lack of confidence on the basis of the decreased learning progress.

As described above, according to the learning progress management unit 240 and the output control unit 270 of the present embodiment, the learning progress can be calculated with high accuracy, and the user can naturally and intuitively perceive the learning progress.

<<1.6. Output Control of Additional Information Regarding Feedback Request>>

Next, output control of additional information regarding a feedback request according to the present embodiment will be described in detail. One of characteristics of the output control unit 270 according to the present embodiment is to further control output of additional information for requesting the user to provide a feedback, in addition to the above-described control of the output expression.

At this time, the expression determination unit 272 according to the present embodiment may control output content, output timing, output modal, the number of outputs, a target user, and the like of the additional information on the basis of the learning progress dynamically calculated by the learning progress management unit 240. Furthermore, the synthesis unit 274 according to the present embodiment can synthesize the additional information generated by the expression determination unit 272 with the response information and output the response information.

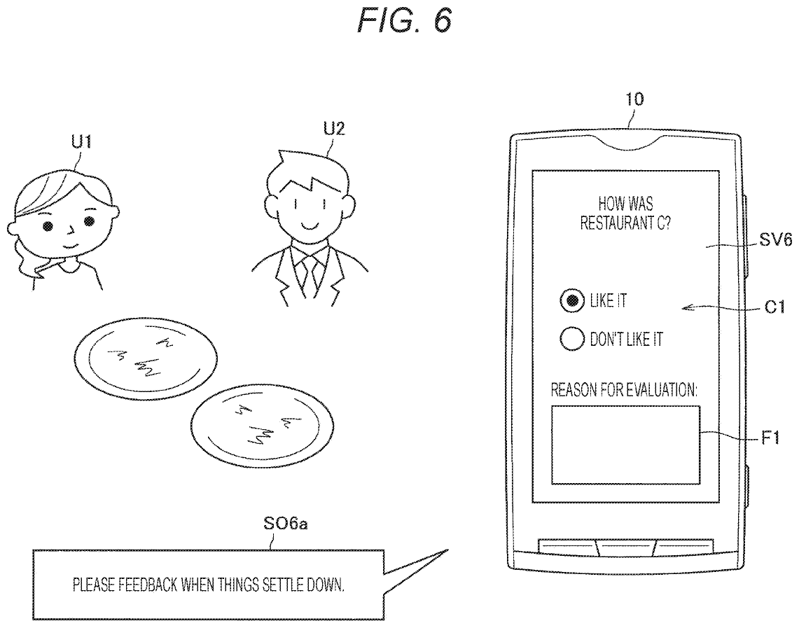

FIG. 6 is a diagram for describing output control of the additional information regarding a feedback request according to the present embodiment. FIG. 6 illustrates an example of a case where the output control unit 270 causes the additional information to be output in a case where the learning progress is relatively low.

For example, the output control unit 270 according to the present embodiment may cause the information processing terminal 10 to output the additional information regarding a feedback request at timing when the user's action corresponding to the response information has been completed, in the case where the learning progress is relatively low.

For example, in a case where information regarding restaurant recommendation has been presented as the response information, the output control unit 270 according to the present embodiment may cause the additional information regarding a feedback request to be output at the timing when the user finishes the meal at the restaurant. The output control unit 270 may cause the information processing terminal 10 to repeatedly output the additional information until the learning progress becomes sufficiently high.

At this time, the output control unit 270 may dynamically determine the output content regarding the additional information on the basis of the learning progress. The above-described output content includes, for example, feedback items. The output control unit 270 according to the present embodiment can determine content, granularity, number, feedback method, and the like of the feedback items on the basis of the learning progress, for example. That is, the output control unit 270 according to the present embodiment can cause the information processing terminal 10 to output the additional information by which a more detailed feedback can be obtained as the learning progress is lower.

For example, in the example illustrated in FIG. 6, the output control unit 270 causes the information processing terminal 10 to output an option C1 for obtaining an overall evaluation regarding a restaurant C and a field F1 for requesting an input of an evaluation reason as visual information SV6.

As described above, the output control unit 270 according to the present embodiment can generate the additional information for obtaining information necessary for improving the accuracy of the response information as a feedback according to the learning progress. The output control unit 270 can determine the additional information for obtaining a feedback regarding items such as a reason for choosing the restaurant, a request for improvement, food preferences, atmosphere preferences, location preferences, suitability for situations (for example, companions), budget, and recent history (recently eaten food, restaurants visited, and the like), in addition to the items illustrated in FIG. 6, on the basis of the learning progress in each case, for example. More specifically, in a case where the learning progress is high, the output control unit 270 may output the additional information for obtaining only the pros and cons for the response information as an option. Furthermore, in a case where the learning progress is low, the output control unit 270 can obtain a detailed feedback from the user by increasing the number of items and a feedback in a free entry form. At this time, the output control unit 270 may narrow down the items on the basis of the priority according to the learning progress.

Furthermore, in the case where the learning progress is low, the output control unit 270 according to the present embodiment may also request a feedback from other users who accompany the user who made the inquiry. In the example illustrated in FIG. 6, the output control unit 270 can cause a user U2 who has eaten at the restaurant together with the user U1 to output the additional information requesting a feedback.

Furthermore, in a case where the information processing terminal 10 includes a plurality of output modals (for example, sound and visual information), the output control unit 270 according to the present embodiment can increase an opportunity to obtain a feedback from the user by using all the available output modals or using an output modal being used by the user.

Furthermore, the output control unit 270 according to the present embodiment can cause the information processing terminal 10 to output additional information requesting a feedback later in a case of determining that the user has a difficulty in performing an immediate feedback from a result of state recognition of the user and the like, for example. In the example illustrated in FIG. 6, the output control unit 270 causes the information processing terminal 10 to output the additional information including the above content as a voice utterance SO6a.

As described above, according to the output control unit 270 of the present embodiment, in a case where the learning progress is relatively low, the effective output content, output timing, output modal, number of outputs, and target user can be set, and a feedback can be requested to the user, whereby effective learning can be realized.

Meanwhile, in a case where the learning progress is sufficiently high, the output control unit 270 may cause the additional information requesting a simple feedback to be output only in a case where the user is not busy or a feedback has not been received for a while. At this time, the output control unit 270 may prioritize not hindering user's behavior and cause only an output modal not used by the user to output the additional information.

According to the function of the output control unit 270 of the present embodiment, an effect of maintaining a sufficient learning progress without increasing the burden on the user more than necessary is expected.

<<1.7. Flow of Control>>

Next, a flow of control by the information processing server 20 according to the present embodiment will be described. First, output expression control based on the learning progress by the information processing server 20 will be described.

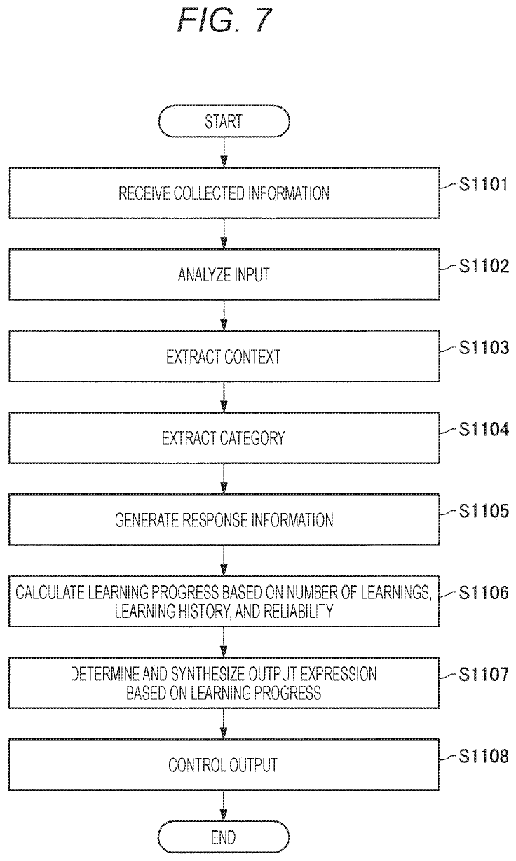

FIG. 7 is a flowchart illustrating a flow of control of the output expression based on the learning progress by the information processing server 20 according to the present embodiment.

Referring to FIG. 7, first, the terminal communication unit 280 receives collected information from the information processing terminal 10 (S1101). The above collected information includes the sound information including a user's utterance, the input sentence based on device operation, the image information, and the sensor information.

Next, the input analysis unit 210 executes an input analysis based on the collected information received in step S1101 (S1102). Note that the input analysis in step S1102 includes text conversion of the voice utterance and various types of recognition processing.

Next, the context analysis unit 220 extracts contest on the basis of the result of the input analysis in step S1102 (S1103).

Next, the category extraction unit 230 executes category extraction on the basis of the result of the input analysis in step S1102 and the context extracted in step S1103 (S1104).

Next, the response generation unit 260 generates the response information on the basis of the result of the input analysis in step S1102, the context extracted in step S1103, and the knowledge learned by the learning function unit 250 (S1105).

Next, the learning progress management unit 240 calculates the learning progress for the category extracted in step 1104 (S1106). At this time, the learning progress management unit 240 may dynamically calculate the learning progress on the basis of the number of learnings, the learning history, the reliability, and the like.

Next, the output control unit 270 determines the output expression on the basis of the learning progress calculated in step S1106, and synthesizes the output expression with the response information generated in step S1105 (S1107).

Next, the terminal communication unit 280 transmits the control signal regarding the response information synthesized with the output expression in step S1107 to the information processing terminal 10, and the response information is output (S1108).

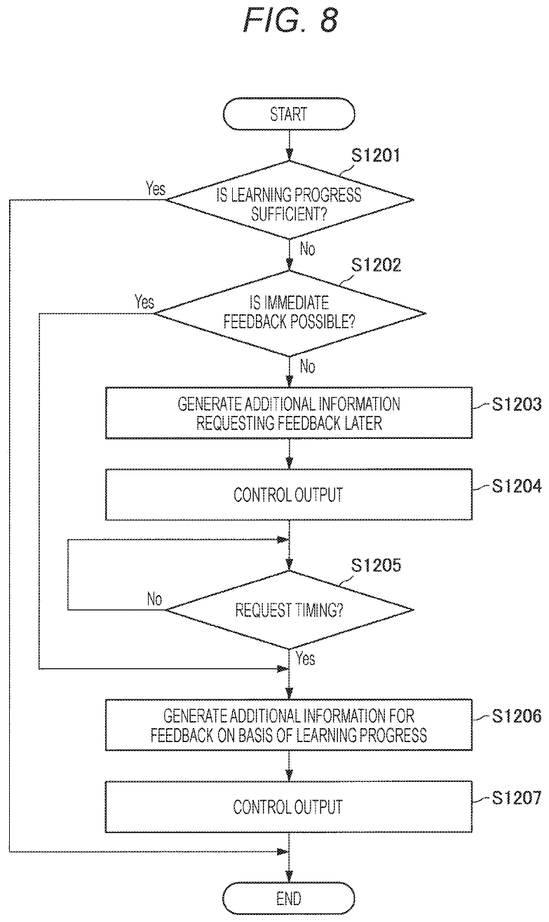

Next, a flow of output control of the additional information regarding the feedback request will be described. FIG. 8 is a flowchart illustrating a flow of output control of the additional information regarding the feedback request by the information processing server 20 according to the present embodiment.

Referring to FIG. 8, first, the output control unit 270 determines whether or not the learning progress calculated by the learning progress management unit 240 has a sufficiently high value (S1201).

Here, in a case where the learning progress has a sufficiently high value (S1201: Yes), the output control unit 270 may terminate the processing regarding the output control of the additional information. Meanwhile, as described above, the output control unit 270 may cause the additional information to be output depending on the situation even in a case where the learning progress is high.

On the other hand, in a case where the learning progress is not sufficient (S1201: No), the output control unit 270 subsequently determines whether or not the user can provide an immediate feedback (S1202).

Here, in a case where the user cannot provide an immediate feedback (S1202: No), the output control unit 270 generates the additional information requesting a feedback later (S1203) and causes the information processing terminal 10 to output the additional information (S1204).

Next, the output control unit 270 repeatedly determines a status until feedback request timing comes, that is, until the user becomes able to provide a feedback (S1205).

Here, in a case where the user becomes able to provide a feedback (S1205: Yes), or in a case where the user can provide an immediate feedback in step S1202 (S1202: Yes), the output control unit 270 generates the additional information regarding the feedback request on the basis of the learning progress (S1206) and causes the information processing terminal 10 to output the additional information (S1207).

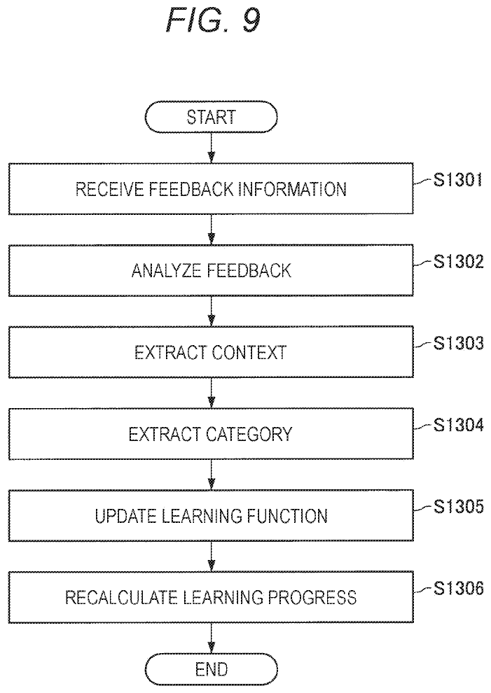

Next, a flow of update of the learning function based on the feedback by the information processing server 20 according to the present embodiment will be described. FIG. 9 is a flowchart illustrating a flow of update of the learning function based on the feedback by the information processing server 20 according to the present embodiment.

Referring to FIG. 9, first, the terminal communication unit 280 receives feedback information from the information processing terminal 10 (S1301).

Next, the input analysis unit 210 analyzes the feedback information received in step S1301 (S1302).

Next, the context analysis unit 220 extracts context information for narrowing down the learning function to be updated (S1303).

Next, the category extraction unit 230 extracts the category for narrowing down the learning function to be updated (S1304).

Next, the learning function unit 250 executes learning function update processing on the basis of the feedback information received in step S1301 (S1305).

Next, the learning progress management unit 240 recalculates the learning progress on the basis of the feedback information received in step S1301 and a learning function update result in step S1305 (S1306).

### 2. HARDWARE CONFIGURATION EXAMPLE

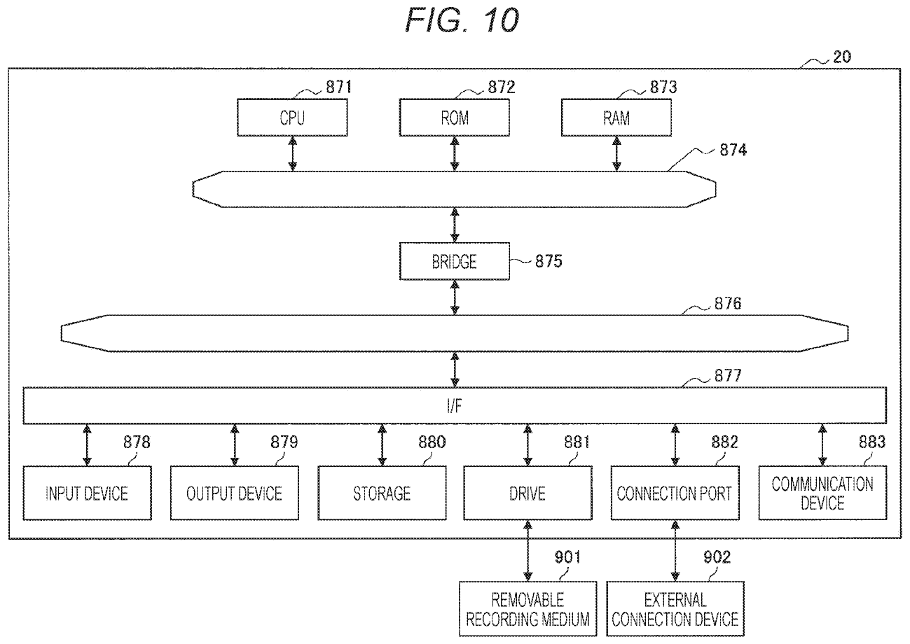

Next, a hardware configuration example common to the information processing terminal 10 and the information processing server 20 according to the embodiment of the present disclosure will be described. FIG. 10 is a block diagram illustrating a hardware configuration example of the information processing server 20 according to the embodiment of the present disclosure. Referring to FIG. 10, the information processing server 20 includes, for example, a CPU 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the configuration elements may be omitted. Furthermore, a configuration element other than the configuration elements illustrated here may be further included.

(CPU 871)

The CPU 871 functions as, for example, an arithmetic processing unit or a control unit, and controls the overall operation or part of the configuration elements on the basis of various programs recorded in the ROM 872, RAM 873, storage 880, or removable recording medium 901.

(ROM 872 and RAM 873)

The ROM 872 is a means for storing a program read by the CPU 871, data used for calculation, and the like. The RAM 873 temporarily or permanently stores, for example, a program read by the CPU 871, various parameters that change as appropriate when the program is executed, and the like.

(Host Bus 874, Bridge 875, External Bus 876, and Interface 877)

The CPU 871, the ROM 872, and the RAM 873 are connected to one another via, for example, the host bus 874 capable of high-speed data transmission. Meanwhile, the host bus 874 is connected to the external bus 876 having a relatively low data transmission speed via the bridge 875, for example. Furthermore, the external bus 876 is connected to various configuration elements via the interface 877.

(Output Device 878)

As the input device 878, for example, a mouse, a keyboard, a touch panel, a button, a switch, a lever, and the like are used. Moreover, as the input device 878, a remote controller (hereinafter referred to as a remote controller) capable of transmitting a control signal using infrared rays or other radio waves may be used. Furthermore, the input device 878 includes a voice input device such as a microphone.

(Output Device 879)

The output device 879 is a device that can visually or audibly notify a user of acquired information, such as a display device such as a cathode ray tube (CRT), an LCD, or an organic EL, an audio output device such as a speaker or a headphone, a printer, a mobile phone, or a facsimile, for example. Furthermore, the output device 879 according to the present disclosure includes various vibration devices that can output tactile stimuli.

(Storage 880)

The storage 880 is a device for storing various data. As the storage 880, for example, a magnetic storage device such as a hard disk drive (HDD), a semiconductor storage device, an optical storage device, a magneto-optical storage device, or the like is used.

(Drive 881)

The drive 881 is a device that reads information recorded on the removable recording medium 901 such as a magnetic disk, an optical disk, a magneto-optical disk, or a semiconductor memory, or writes information to the removable recording medium 901, for example.

(Removable Recording Medium 901)

The removable recording medium 901 is, for example, a DVD medium, a Blu-ray (registered trademark) medium, an HD-DVD medium, various semiconductor storage media, or the like. Of course, the removable recording medium 901 may be, for example, an IC card on which a non-contact IC chip is mounted, an electronic device, or the like.

(Connection Port 882)

The connection port 882 is a port for connecting an external connection device 902 such as a universal serial bus (USB) port, an IEEE1394 port, a small computer system interface (SCSI), an RS-232C port, or an optical audio terminal, for example.

(External Connection Device 902)

The external connection device 902 is, for example, a printer, a portable music player, a digital camera, a digital video camera, an IC recorder, or the like.

(Communication Device 883)

The communication device 883 is a communication device for being connected to a network, and is, for example, a communication card for wired or wireless LAN, a Bluetooth (registered trademark), a wireless USB (WUSB), a router for optical communication, an asymmetric digital subscriber line (ADSL) router, one of various communication modems, or the like.

### 3. CONCLUSION

As described above, the information processing server 20 according to the embodiment of the present disclosure has the function to control an output of the response information to the user. At this time, one of the characteristics of the information processing server 20 according to the embodiment of the present disclosure is to control the output expression of the response information on the basis of the learning progress of learning regarding generation of the response information. Such a configuration enables the user to more naturally and intuitively perceive the learning progress regarding information presentation. becomes possible.

Although the favorable embodiment of the present disclosure has been described in detail with reference to the accompanying drawings, the technical scope of the present disclosure is not limited to such examples. It is obvious that persons having ordinary knowledge in the technical field of the present disclosure can conceive various modifications or alterations within the scope of the technical idea described in the claims, and the modifications and alterations are naturally understood to belong to the technical scope of the present disclosure.

Furthermore, the steps in the processing of the information processing server 20 of the present specification do not necessarily need be processed chronologically in the order described as the flowcharts. For example, the steps regarding the processing of the information processing server 20 may be processed in an order different from the order described as the flowcharts or may be processed in parallel.

Note that following configurations also belong to the technical scope of the present disclosure.

(1)

An information processing apparatus including:

an output control unit configured to control an output of response information to a user, in which

the output control unit controls output expression of the response information on the basis of learning progress of learning regarding generation of the response information.

(2)

The information processing apparatus according to (1), in which

the output control unit synthesizes the output expression determined on the basis of the learning progress with response information generated on the basis of input information.

(3)

The information processing apparatus according to (1) or (2), in which

the output control unit controls the output expression on the basis of the learning progress calculated for each category of the learning regarding generation of the response information.

(4)

The information processing apparatus according to any one of (1) to (3), in which

the learning progress is dynamically calculated on the basis of at least any one of a number of learnings, a learning history, or a reliability.

(5)

The information processing apparatus according to any one of (1) to (4), in which

the learning progress is dynamically calculated using a factor value regarding a determination factor and a weighting factor for each determination factor, and

the weighting factor for each determination factor is determined according to a characteristic of a category of the learning regarding generation of the response information.

(6)

The information processing apparatus according to any one of (1) to (5), in which

the learning progress is dynamically calculated on the basis of a feedback of the user to the response information.

(7)

The information processing apparatus according to any one of (1) to (6), in which

the output expression includes at least any one of a sentence content, an output mode, or an output operation regarding the response information, and

the output control unit dynamically changes at least any one of the sentence content, the output mode, or the output operation on the basis of the learning progress.

(8)

The information processing apparatus according to any one of (1) to (7), in which

the output control unit determines the output expression for causing the user to perceive the learning progress on the basis of the learning progress.

(9)

The information processing apparatus according to (8), in which

the output control unit determines output expression suggesting that there is a possibility that usefulness of the response information to the user is not high, in a case where the learning progress is low.

(10)

The information processing apparatus according to (8) or (9), in which

the output control unit determines output expression suggesting that usefulness of the response information to the user being high is determined, in a case where the learning progress is high.

(11)

The information processing apparatus according to any one of (1) to (10), in which

the output control unit further controls an output of additional information requesting the user to provide a feedback to the response information.

(12)

The information processing apparatus according to (11), in which

the output control unit controls at least any one of output content, output timing, output modal, a number of outputs, or a target user, of the additional information, on the basis of the learning progress.

(13)

The information processing apparatus according to (12), in which

the output control unit causes the additional information to be output at timing when an action of the user corresponding to the response information has been completed, in a case where the learning progress is low

(14)

The information processing apparatus according to (12) or (13), in which

the output control unit causes the additional information to be output at timing when the user is not busy, in a case where the learning progress is high.

(15)

The information processing apparatus according to any one of (12) to (14), in which

the output control unit causes additional information requesting a feedback later to be output, in a case where the learning progress is low, and in a case where the user has a difficulty in providing an immediate feedback.

(16)

The information processing apparatus according to any one of (12) to (15), in which

the output content of the additional information includes a feedback item, and

the output control unit determines at least any one of item content, granularity, a number, or a feedback method regarding the feedback item, on the basis of the learning progress.

(17)

The information processing apparatus according to any one of (1) to (16), further including:

a learning progress management unit configured to calculate the learning progress.

(18)

The information processing apparatus according to any one of (1) to (17), in which

the output control unit controls output expression of a voice utterance regarding at least the response information.

(19)

An information processing method including:

by a processor, controlling an output of response information to a user,

the controlling further including

controlling output expression of the response information on the basis of learning progress of learning regarding generation of the response information.

(20)

A program for causing a computer to function as an information processing apparatus including:

an output control unit configured to control an output of response information to a user, in which

the output control unit controls output expression of the response information on the basis of learning progress of learning regarding generation of the response information.

### REFERENCE SIGNS LIST

10 Information processing terminal
110 Display unit
120 Voice output unit
130 Voice input unit
140 Imaging unit
150 Sensor input unit
160 Control unit
170 Server communication unit
20 Information processing server
210 Input analysis unit
220 Context analysis unit
230 Category extraction unit
240 Learning progress management unit
250 Learning function unit
260 Response generation unit
270 Output control unit
272 Expression determination unit
274 Synthesis unit
280 Terminal communication unit

1. An information processing apparatus comprising:
an output control unit configured to control an output of response information to a user, wherein
the output control unit controls output expression of the response information on a basis of learning progress of learning regarding generation of the response information.

2. The information processing apparatus according to claim 1, wherein
the output control unit synthesizes the output expression determined on a basis of the learning progress with response information generated on a basis of input information.

3. The information processing apparatus according to claim 1, wherein
the output control unit controls the output expression on a basis of the learning progress calculated for each category of the learning regarding generation of the response information.

4. The information processing apparatus according to claim 1, wherein
the learning progress is dynamically calculated on a basis of at least any one of a number of learnings, a learning history, or a reliability.

5. The information processing apparatus according to claim 1, wherein
the learning progress is dynamically calculated using a factor value regarding a determination factor and a weighting factor for each determination factor, and
the weighting factor for each determination factor is determined according to a characteristic of a category of the learning regarding generation of the response information.

6. The information processing apparatus according to claim 1, wherein
the learning progress is dynamically calculated on a basis of a feedback of the user to the response information.

7. The information processing apparatus according to claim 1, wherein
the output expression includes at least any one of a sentence content, an output mode, or an output operation regarding the response information, and
the output control unit dynamically changes at least any one of the sentence content, the output mode, or the output operation on a basis of the learning progress.

8. The information processing apparatus according to claim 1, wherein
the output control unit determines the output expression for causing the user to perceive the learning progress on a basis of the learning progress.

9. The information processing apparatus according to claim 8, wherein
the output control unit determines output expression suggesting that there is a possibility that usefulness of the response information to the user is not high, in a case where the learning progress is low.

10. The information processing apparatus according to claim 8, wherein
the output control unit determines output expression suggesting that usefulness of the response information to the user being high is determined, in a case where the learning progress is high.

11. The information processing apparatus according to claim 1, wherein
the output control unit further controls an output of additional information requesting the user to provide a feedback to the response information.

12. The information processing apparatus according to claim 11, wherein
the output control unit controls at least any one of output content, output timing, output modal, a number of outputs, or a target user, of the additional information, on a basis of the learning progress.

13. The information processing apparatus according to claim 12, wherein
the output control unit causes the additional information to be output at timing when an action of the user corresponding to the response information has been completed, in a case where the learning progress is low.

14. The information processing apparatus according to claim 12, wherein
the output control unit outputs the additional information at timing when the user is not busy, in a case where the learning progress is high.

15. The information processing apparatus according to claim 12, wherein
the output control unit causes additional information requesting a feedback later to be output, in a case where the learning progress is low, and in a case where the user has a difficulty in providing an immediate feedback.

16. The information processing apparatus according to claim 12, wherein
the output content of the additional information includes a feedback item, and
the output control unit determines at least any one of item content, granularity, a number, or a feedback method regarding the feedback item, on a basis of the learning progress.

17. The information processing apparatus according to claim 1, further comprising:
a learning progress management unit configured to calculate the learning progress.

18. The information processing apparatus according to claim 1, wherein
the output control unit controls output expression of a voice utterance regarding at least the response information.

19. An information processing method comprising:
by a processor, controlling an output of response information to a user,
the controlling further including
controlling output expression of the response information on a basis of learning progress of learning regarding generation of the response information.

20. A program for causing a computer to function as an information processing apparatus comprising:
an output control unit configured to control an output of response information to a user, wherein
the output control unit controls output expression of the response information on a basis of learning progress of learning regarding generation of the response information.
